(19) United States
(12) Patent Application Publication
(10) Pub. No.: US 2022/0384898 A1
(43) Pub. Date: Dec. 1, 2022

(54) SPACER FOR BATTERY PACK AND BATTERY PACK INCLUDING THE SPACER FOR BATTERY PACK

(71) Applicant: Prime Planet Energy & Solutions, Inc., Tokyo (JP)

(72) Inventor: Yasunori BABA, Kobe-shi (JP)

(21) Appl. No.: 17/750,260

(22) Filed: May 20, 2022

(30) Foreign Application Priority Data
May 28, 2021 (JP) 2021-090273

(51) Int. Cl. H01M 50/291; H01M 50/293

(52) U.S. Cl. CPC H01M 50/291; H01M 50/293

(57) ABSTRACT

A technology that can preferably suppress capacity deterioration of a battery pack is provided. In one preferred mode of a spacer disclosed herein, in a state where the spacer is not disposed between the battery cells, when arbitrary two points on a straight line drawn from a position opposed to a center portion of the electrode body of each of the battery cells to a position opposed to a center portion of an end surface of the positive and negative electrodes-stacked structure are assumed to be a and b in this order in order of closer from the position, average thicknesses between the two broad width surfaces in sections each extending 1.5 cm from a corresponding one of the points a and b as a center in forward and rearward directions along the straight line are assumed to be Da and Db, a relationship Da>Db is satisfied.

### CROSS REFERENCE OF RELATED APPLICATION

The present application claims priority from Japanese Patent Application No. 2021-090273 filed on May 25, 2021, which is incorporated by reference herein in its entirety.

### BACKGROUND

The present disclosure relates to a spacer for a battery pack and a battery pack including the spacer for a battery pack.

Increased importance has been placed on battery packs configured such that a. secondary battery, such as a lithium-ion secondary battery, a nickel-hydrogen battery, or the like, or a power storage element, such as a capacitor or the like, is used as a battery cell and including a plurality of the battery cells, as vehicle mounted power sources or power sources for personal computers, mobile terminals, or the like. Specifically, battery packs configured such that a lithium-ion secondary battery that has a light weight and can obtain high energy density is used as a battery cell have been preferably used for vehicle mounted high output power sources or the like.

Such a battery pack typically has a configuration in which a plurality of battery cells each including an electrode body in which electrodes (a positive electrode and a negative electrode) are stacked with a separator interposed therebetween are arranged along a stacking direction of the electrodes. The battery pack is constructed by electrically connecting adjacent ones of the battery cells in the stacking direction via electrode terminals (a positive terminal and a negative terminal) (see International Patent Publication No. WO2015/075766).

### SUMMARY

Additionally, in recent years, there have been demands for further increasing performance of battery backs. Through an intensive study, the inventor of the present disclosure found that, in a case where gas is generated in an electrode body of a battery cell and the gas stays between an electrode and a separator, a charge and discharge reaction becomes ununiform, and thus, local deterioration can occur. Thus, in a case where a charge and discharge cycle is advanced, unfavorably, there is a probability that a capacity retention ratio of a battery pack is reduced (that is, capacity deterioration occurs).

In view of the foregoing, the present disclosure has been devised and it is therefore a major object of the present disclosure to provide a technology that can preferably suppress the capacity deterioration of a battery pack.

In order to realize the above-described object, the present disclosure provides a spacer for a battery pack having a sheet-like shape and disposed between arranged battery cells. A battery pack configured such that a plurality of battery cells each including an electrode body having a positive and negative electrodes-stacked structure in which a positive electrode and a negative electrode are stacked with a separator interposed therebetween are arranged in a stacking direction of the positive and negative electrodes. The spacer for a battery pack includes two broad width surfaces each being opposed to a corresponding one of the battery cells adjacent to the spacer in the stacking direction in a case where the spacer is disposed between the battery cells. In the spacer in a state where the spacer is not disposed between the battery cells, in a case where, when arbitrary two points on a straight line drawn from a position opposed to a center portion of the electrode body of each of the battery cells to a position opposed to a center portion of an end surface of the positive and negative electrodes-stacked structure are assumed to be a and b in this order in order of closer from the position opposed to the center portion of the electrode body, average thicknesses between the two broad width surfaces in sections each extending 1.5 cm from a corresponding one of the points a and b as a center in forward and rearward directions along the straight line are assumed to be Da and Db, a relationship Da>Db is satisfied (which may be hereinafter described as “having a gradient”). By using the spacer for a battery pack having the above-described configuration, the capacity deterioration of the battery pack can be preferably suppressed.

The spacer for a battery pack disclosed herein is preferably formed of an elastic body. By using the spacer for a battery pack having the above-described configuration, the capacity deterioration of the battery pack can be more preferably suppressed. More preferably, a compression elasticity modulus of the elastic body is 120 MPa or less,

In one preferred embodiment of the spacer for a battery pack disclosed herein, an elastic surface including a plurality of raised portions formed of an elastic body is formed on at least one of the two broad width surfaces. In the above-described configuration, an elasticity due to crushing of the raised portions can be achieved, and therefore, pushing out of the gas in the electrode body in a more gradual (effective) manner can be realized.

In one preferred embodiment of the spacer for a battery pack disclosed herein, in the state where the spacer for a battery pack is disposed between the battery cells, when each of the battery cells adjacent to the spacer in the stacking direction has a state of charge (SOC) of 90% or more, a state where the thickness between the two broad width surfaces is flat is realized.

In one preferred embodiment of the spacer for a battery pack disclosed herein, when the spacer in a state where the spacer is not disposed between the battery cells is cut into two in a perpendicular direction to the thickness between the two broad width surfaces, the relationship Da>Db is satisfied in the two cut bodies. By using the spacer for a battery pack having the above-described configuration, the capacity deterioration of the battery pack can be more preferably suppressed.

In one preferred embodiment of the spacer for a battery pack disclosed herein, in the spacer in a state where the spacer is not disposed between the battery cells, when a straight line drawn from the position opposed to the center portion of the electrode body of each of the battery cells to the position opposed to the center position of the end surface of the positive and negative electrodes-stacked structure is equally divided into three and average thicknesses between the two broad width surfaces in regions obtained by equally dividing the straight line into three are assumed to be D₁, D₂, and D₃ in this order in order of closer from the position opposed to the center position of the electrode body, a relationship Dₙ>Dₙ₊₁ (where n is 1 or 2) is satisfied. By using the spacer for a battery pack having the above-described configuration, the capacity deterioration of the battery pack can be more preferably suppressed.

In another aspect, the present disclosure provides a battery pack including the spacer for a battery pack disclosed herein. According to the above-described configuration, a battery pack in which a capacity deterioration is preferably suppressed is provided.

In one preferred embodiment of the battery pack disclosed herein, each of the battery cells is configured such that the electrode body is covered by a laminated exterior body. The battery cell including the laminated exterior body is likely to expand during charging a battery, as compared to a battery cell including a battery case. Therefore, the battery cell including the laminated exterior body is a preferable target to which the technology disclosed herein is applied.

### BRIEF DESCRIPTION OF THE DRAWINGS

FIG. 1 is a schematic view illustrating a battery pack according to one embodiment.

FIG. 2 is a plan view schematically illustrating a configuration of a battery cell of the battery pack of FIG. 1.

FIG. 3 is a schematic view illustrating a spacer for a battery pack of the battery pack of FIG. 1.

FIG. 4A, FIG. 4B, and FIG. 4C are schematic views each illustrating a mechanism in which air bubbles (gas) caught in an electrode body are discharged to outside of the electrode body in a case where the battery pack including the spacer for a battery pack according to the one embodiment is charged.

FIG. 5A, FIG. 5B, and FIG. 5C are schematic views each illustrating a configuration in a case where a battery pack including a known spacer for a battery pack is charged.

FIG. 6 is a view illustrating a thickness in a center and a thickness in an end portion in the spacer for a battery pack according to the one embodiment.

FIG. 7 is a schematic view illustrating two cut bodies obtained in a case where the spacer for a battery pack according to the one embodiment is cut into two in a perpendicular direction to a thickness between two broad width surfaces.

FIG. 8 is a view illustrating average thicknesses between two broad width surfaces in regions defined by equally dividing a straight line into three when the straight line drawn from a position opposed to a center portion of the electrode body of the battery cell in the spacer for a battery pack according to the one embodiment to a position opposed to a center portion of an end surface of a positive and negative electrodes-stacked structure.

FIG. 9 is a schematic view illustrating a spacer for a battery pack according to another embodiment.

FIG. 10 is a schematic view illustrating a spacer for a battery pack according to still another embodiment.

### DETAILED DESCRIPTION

With reference to the accompanying drawings, some preferred embodiments of the technology disclosed herein will be described below. Note that matters other than matters specifically mentioned in this specification and necessary for carrying out the present disclosure (for example, general configuration and manufacturing process of a battery that does not characterize the present disclosure) can be understood as design matters for those skilled in the art based on the related art in the related field. The present disclosure can be carried out based on the contents disclosed in this specification and the common general technical knowledge in the field. Moreover, the following embodiments are not intended to limit the technology disclosed herein.

Note that, in this specification, A to B (A and B are arbitrary numeral values) indicative of a predetermined numerical range means “A or more and B or less.” Therefore, it includes a case where the numerical range is a range of more than A and less than B.

Note that, in this specification, the term “battery” refers to an overall power storage device that can extract electric energy and is a concept including a primary batter and a secondary battery. In this specification, the term “secondary battery” refers to an overall power storage device that can be repeatedly charged and discharged and is a concept including a so-called accumulator (a chemical battery), such as a lithium-ion secondary battery, a nickel-hydrogen battery, or the like, and a capacitor (a physical battery), such as an electrical double-layered capacitor or the like.

### Battery Pack 1

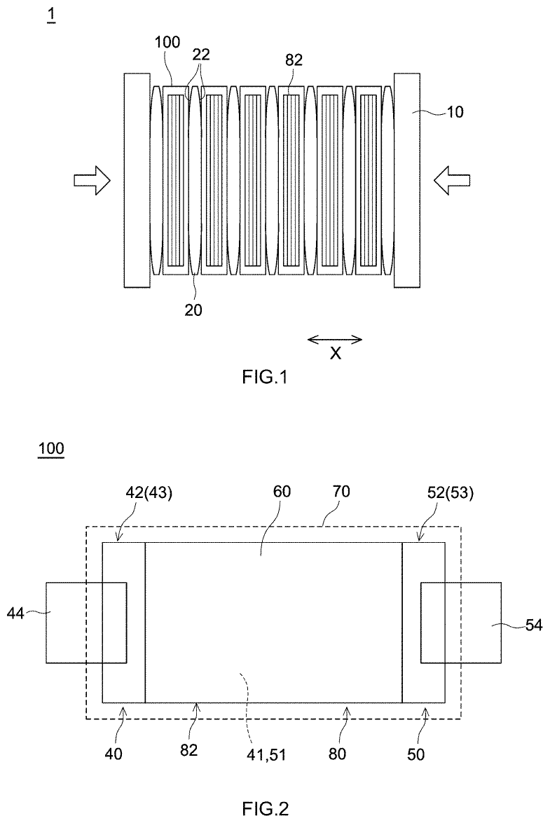

First, a configuration of a battery pack 1 according to this embodiment will be described with reference to FIG. 1. As illustrated in FIG. 1, roughly speaking, the battery pack 1 is configured such that a plurality of battery cells 100 each including an electrode body having a positive and negative electrodes-stacked structure 82 in which a positive electrode and a negative electrode are stacked with a separator interposed therebetween are arranged in a stacking direction X of the positive and negative electrodes. The battery pack 1 includes a sheet-like spacer 20 disposed between the arranged battery cells. The battery pack 1 according to this embodiment is configured to be constrained by two constraining plates 10 and a constraining pressure can be similar to a constraining pressure in a known battery pack. Note that, for convenience, a detail configuration near an electrode terminal is omitted in FIG. 1. The battery cells 100 are connected to each other in series or in parallel via an electrode terminal.

### Battery Cell 100

Next, a configuration of the battery cell 100 of the battery pack 1 according to this embodiment will be briefly described with reference to FIG. 2. Note that a case where the battery cell 100 includes a stacked electrode body 80 as an electrode body will be described as an example below. However, it is not intended to limit the electrode body to the above-described type. The electrode body may be a so-called wound electrode body or the like obtained, for example, by superimposing a positive electrode sheet (a positive electrode) and a negative electrode sheet (a negative electrode) with a separator interposed therebetween, winding the positive and negative electrode sheets, and press-processing the positive and negative electrode sheets into a flat shape. A case where an exterior body 70 formed of a laminated film is used will be described as an example below. However, it is not intended to limit the exterior body to the above-described type. The exterior body may be, for example, a battery case made of metal and having a hexahedral shape, or the like. Note that the battery cell including the laminated exterior body is likely to easily expand during charging the battery, as compared to a battery cell including a battery case. Therefore, the battery cell including the laminated exterior body is a preferable target to which the technology disclosed herein is applied.

FIG. 2 is a plan view schematically illustrating a configuration of the battery cell 100 including the stacked electrode body 80. As illustrated in FIG. 2, roughly speaking, the battery cell 100 includes the stacked electrode body 80 and the exterior body 70 housing the stacked electrode body. The stacked electrode body 80 is disposed between a pair of laminated films and an unillustrated welding member is formed by welding outer circumferential edge portions of the laminated films, and thus, the exterior body 70 housing the stacked electrode body 80 is formed.

Although not illustrated in detail in FIG. 2, the stacked electrode body 80 according to this embodiment is formed by stacking a plurality of rectangular positive sheets 40 and negative sheets 50 (which will be hereinafter also collectively referred as “electrode sheets”) with a separator sheet 60 having a similar rectangular shape interposed therebetween. The above-described electrode sheet includes current collectors (a positive electrode current collector 42 and a negative electrode current collector 52) that are foil-like metal members and electrode active material layers (a positive electrode active material layer 41 and a negative electrode active material layer 51) formed on a surface (one surface or both surfaces) of a corresponding current collector.

In each of the rectangular electrode sheets of this embodiment, an active material layer non-forming portion (a positive electrode active material layer non-forming portion 43 and a negative electrode active material layer non-forming portion 53) in which an active material layer is not formed and the corresponding current collector is exposed is formed in one side edge portion in a longer side direction. The electrode sheets are superimposed such that the positive electrode active material layer non-forming portion 43 protrudes from one side edge potion and the negative electrode active material layer non-forming portion 53 protrudes from the other side edge potion, and thus, the stacked electrode body 80 is formed. A core portion (that is, the positive and negative electrodes-stacked structure 82) in which the electrode active material layers of the electrode sheets are superimposed is formed in a center portion of the stacked electrode body in the longer side direction. A positive electrode terminal connection portion in which a plurality of the positive electrode active material layer non-forming portions 43 are superimposed is formed in one side edge portion in the longer side direction and a negative electrode terminal connection portion in which a plurality of the negative electrode active material layer non-forming portions 53 are superimposed is formed in the other side edge portion. A positive electrode current collector terminal 44 is connected to the positive electrode current collector terminal connection portion and a negative electrode current collector terminal 54 is connected to the negative electrode current collector terminal connection portion.

Herein, the battery cell 100 may be, for example, a nonaqueous electrolyte secondary battery and may be an all-solid battery. In a case where the battery cell 100 is the nonaqueous electrolyte secondary battery, the stacked electrode body 80 in which the insulative separator sheet 60 is inserted between the electrode sheets is used and a nonaqueous electrolyte is housed inside the exterior body 70. On the other hand, in a case where the battery cell 100 is the all-solid battery, the stacked electrode body 80 in which a solid electrolyte layer (corresponding to the separator sheet 60) is inserted between the electrode sheets is used. Note that, as the above-described components (specifically, the electrode sheets, the separator sheet, the solid electrolyte layer, the nonaqueous electrolyte, or the like), components that can be used for a secondary battery of the above-described type can be used without any particular limitation and do not characterize the present disclosure, and therefore, detailed description will be omitted.

### Spacer 20 For Battery Pack

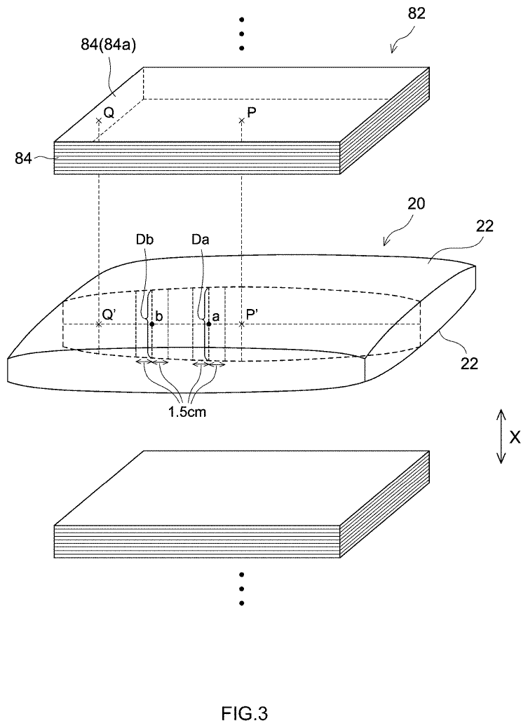

Subsequently, the spacer 20 for a battery pack of the battery pack 1 according to this embodiment will be described with reference to FIG. 1 and. FIG. 3. First, as illustrated in FIG. 1, the spacer 20 for a battery pack has two broad width surfaces 22 each being opposed to a corresponding one of the battery cells 100 adjacent thereto in the stacking direction X in a case where the spacer 20 is disposed between the battery cells. As illustrated in FIG. 3, the spacer 20 for a battery pack has a feature that, in a state where the spacer 20 is not disposed between the battery cells (for example, in a state before the spacer 20 is disposed between the battery cells, or a state after the battery is disassembled), when arbitrary two points on a straight line drawn from a position P′ opposed to a center position P of the stacked electrode body 80 of the battery cell 100 to a position Q′ opposed to a center portion Q of an end surface 84a of the positive and negative electrodes-stacked structure are assumed to be a and b in this order in order of closer from the position P′, in a case where average thicknesses of sections each extending 1.5 cm from a corresponding one of the points a and b as a center both in a forward direction and a reward direction along the straight line are assumed to be Da and Db, a relationship Da>Db is satisfied. That is, even when any points are selected as the two points a and b (however, as the two points a and b, points each in which a section extending 1.5 cm both in the forward and rearward directions can be ensured are selected), Da>Db is satisfied. Herein, for example, the average thickness Da between the two broad wide surfaces 22 in the section extending 1.5 cm from the point a as a center both in the forward and rearward directions along the straight line can be defined as follows. That is, the section extending from a portion located at 1.5 cm from the point a in the forward direction (that is, in a left direction in FIG. 3) to a portion located at 1.5 cm from the point a in the rear direction (that is, a right direction in FIG. 3) is equally divided into ten and the thickness between the two broad width surfaces 22 is measured at eleven points including ones at both ends. An average value calculated using the respective thicknesses at the eleven points can be used as the average thickness Da. Similar applied to Db. Note that, although there is no particular limitation on a distance between the above-described two points a and b, in view of accurately measuring an average thickness of the spacer for a battery pack, the distance can be generally 1 mm or more, preferably 3 mm or more, and more preferably 5 mm or more. Moreover, although there is no particular limitation on an upper limit of the distance between the two points a and b, the distance can be generally 1.5 cm or less, and preferably 1 cm or less. Note that the distance between the two points a and b is not limited to the above-described range.

Note that the stacked electrode body 80 according to this embodiment includes three more end surfaces of the positive and negative electrodes-stacked structure other than the end surface 84a in three other positions (see the end surfaces 84 in FIG. 3). Therefore, when arbitrary two points on a straight line drawn from the position P′ to a corresponding position opposed to each of the end surfaces 84 in the three other positions are assumed to be a and b in this order in order of closer from the position P′, in a case where average thicknesses between the broad width surfaces 22 in sections each extending 1.5 cm from a corresponding one of the two points a and b as a center both in forward and rearward directions along the straight line are assumed to be Da and Db, the relationship Da>Db is satisfied. By using the spacer 20 for a battery pack having the above-described configuration, capacity deterioration of the battery pack 1 can be preferably suppressed. The spacer 20 for a battery pack can be manufactured, for example, by molding using a metal mold, or the like.

In a case where the spacer for a battery pack is small and the above-described two points a and b cannot be selected, two points can be selected as follows. That is, arbitrary two points are selected on a straight line drawn from a position opposed to a center potion of a stacked electrode body of a battery cell to a position opposed to a center portion of an end surface and the two points are assumed to be x and y in this order in order of closer from the position opposed to the center position. Then, each of average thicknesses Dx and Dy between the two broad width surfaces for sections from the two points to the position opposed to the center portion may he calculated and Dx>Dy may be confirmed. Herein, for example, the average thickness Dx between the two broad width surfaces for the section from the point x to the position opposed to the center position can be defined as follows. That is, the section from the point x to the position opposed to the center portion is equally divided into ten and the thickness between the two broad width surfaces is measured at eleven points including ones at both ends. An average value calculated using the respective thicknesses at the eleven points can be used as the average thickness Dx. Similar applies to Dy.

A reason why effects of the technology disclosed herein are achieved by employing the above-described configuration should interpreted particularly in a limited manner, but the following can be considered as a possible reason.

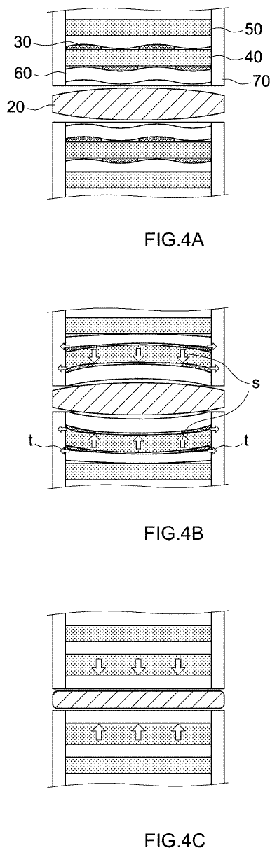

FIG. 4A, FIG. 4B, and FIG. 4C are schematic views each illustrating a mechanism in which air bubbles (gas) 30 caught in an electrode body are discharged to outside of the electrode body in a case where the battery pack 1 including the spacer 20 for a battery pack is charged. Herein, FIG. 4A is a schematic view illustrating a portion of the battery pack 1 before charging, FIG. 4B is a schematic view illustrating the portion of the battery pack 1 during a charging process, and FIG. 4C is a schematic view illustrating the portion of the battery pack 1 after charging (typically, a SOC is 90% or more). As illustrated in FIG. 4B, when the stacked electrode body 80 expands along an arrow s during the charging process of charging the battery pack 1, a pressure moves from a center to outside with respect to an electrode surface due to the existence of the spacer 20 for a battery (see an arrow t). Thus, the air bubbles 30 caught in the electrode body can be efficiently discharged to the outside of the electrode body. Therefore, it is considered that, according to the spacer 20 for a battery, a charge and discharge reaction by a battery pack is uniformized and capacity deterioration can be preferably suppressed. As illustrated in FIG. 4C, the spacer 20 for a battery pack can be realized in a state where the thickness between the two broad width surfaces is flat when each of the adjacent battery cells in the stacked direction X has a SOC of 90% or more.

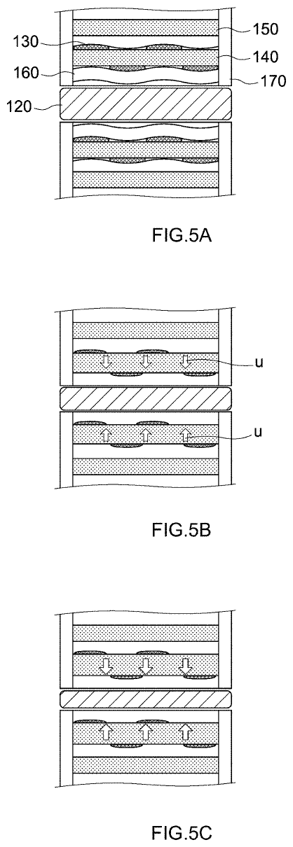

On the other hand, FIG. 5A, FIG. 5B, and FIG. 5C are schematic views each illustrating a configuration in a case where a battery pack including a known spacer 120 for a battery pack is charged (the reference numerals 130, 140, 150, 160, and 170 in FIG. 5A, FIG. 5B, and FIG. 5C correspond to the reference numerals 30, 40, 50, 60, and 70 in FIG. 4A, FIG. 4B, and FIG. 4C, respectively). Herein, FIG. 5A is a schematic view illustrating a portion of the battery pack 1 before charging, FIG. 5B is a schematic view illustrating the portion of the battery pack 1 during a charging process, and FIG. 5C is a schematic view illustrating the portion of the battery pack 1 after charging (typically, a SOC is 90% or more). As illustrated in FIG. 5B, in a case where the electrode body expands during the charging process of charging the battery pack 1, a pressure is uniformly applied to an electrode surface (see an arrow u), and therefore, it is difficult to discharge air bubbles 130 (gas) caught in the electrode body to the outside of the electrode body. Therefore, it is considered that a charge and discharge reaction in a battery pack is ununiformized because gas catching is not eliminated, such that capacity deterioration is likely to occur.

Note that, in the description above, “the sections each extending 1.5 cm in the forward direction and the reward direction along the straight line” is defined, which means that, in a section extending 3 cm along a straight line drawn from the position P′ opposed to the center portion P of the stacked electrode body 80 of the battery cell 100 to the position Q′ opposed to the center portion Q of the end surface 84a of the positive and negative electrodes-stacked structure, there may be a portion (that is, a flat portion) having an uniform thickness between the two broad width surfaces 22. This is based on findings of the inventor of the present disclosure that a volume of the gas staying in the electrode body is not directly proportional to a size of the battery but uniform (about several cm at most) and, gas generated in the electrode body can be pushed out to the outside of the electrode body if the portion in which the thickness between the two broad width surfaces is uniform is within 3 cm.

For a material forming the spacer 20 for a battery pack, there is no particular limitation if the effects of the technology disclosed herein are exhibited. For example, the material may be formed of an elastic body. There is no particular limitation on a compression elasticity modulus of the elastic body if the effects of the technology disclosed herein are exhibited. For example, the compression elasticity modulus measured based on JISK7181:2011 can be generally 50 MPa or more, preferably 70 MPa or more, and more preferably 100 MPa or more. An upper limit of the compression elasticity modulus may be generally 200 MPa or less and preferably 150 MPa or less (for example, 120 MPa or less). However, the compression elasticity modulus is not limited to the above-described range.

Examples of the above-described elastic body include, for example, thermosetting elastomer, such as natural rubber, urethane rubber, silicone rubber, ethylene propylene diene rubber, fluorine rubber, or the like, thermoplastic elastomer, such as polystyrene, polyolefin, polyurethane, polyester, polyamide, or the like, or the like.

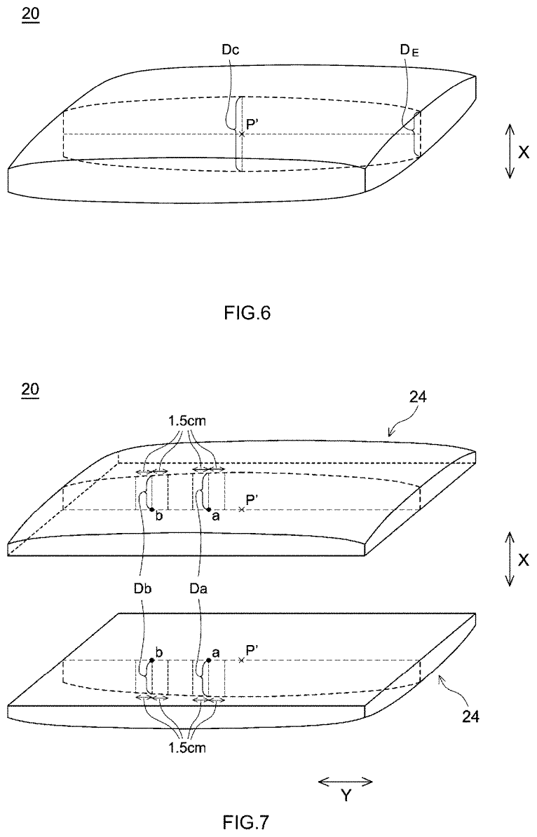

As illustrated in FIG. 6, in a case where it is assumed that a thickness of a center portion of the spacer 20 for a battery pack is D_{C} and a thickness of an end portion thereof is D_{E}, there is no particular limitation on a ratio (D_{C}/D_{E}) of D_{C} to D_{E} if the effects of the technology disclosed herein are exhibited. The ratio can be generally 1.2 or more, preferably 1.5 or more, and more preferably 2.0 or more. Moreover, the ratio (D_{C}/D_{E}) can be generally 10 or less, preferably 8.0 or less, and mor preferably 6.0 or more. The ratio (D_{C}/D_{E}) can be, for example, in a range of 1.5 to 6.0.

There is no particular limitation on respective specific ranges of magnitude of any of a thickness of the stacked electrode body 80 in the stacking direction X, the thickness D_{C}, and the thickness D_{E} if the effects of the technology disclosed herein are exhibited. For example, in a case where the thickness of the stacked electrode body 80 in the stacking direction X is 10 mm to 100 mm, the thickness D_{C} can be about 1 mm to 10 mm, and the thickness D_{E} can be about 0.5 mm to 8 mm.

In a preferred mode, as illustrated in FIG. 8, in the spacer in a state where the spacer is not disposed in the battery cells, when the straight line drawn from the position P′ opposed to the center portion P of the stacked electrode body 80 of the battery cell 100 to the position Q′ opposed to the center position Q of the end surface 84a of the positive and negative electrodes-stacked structure 82 is equally divided into three and average thicknesses between the two broad width surfaces 22 in regions obtained by equally dividing the straight line into three are D₁, D₂, and D₃ in this order in order of closer from the position P′, Dₙ>Dₙ₊₁ (where n is 1 or 2) is satisfied. Note that the stacked electrode body 80 according to this embodiment includes three more end surfaces of the positive and negative electrodes-stacked structure other than the end surface 84a in three other positions (see the end surfaces 84 of FIG. 3). Therefore, when a straight line drawn from the position P′ to a position opposed to each of respective center portions of the three end surfaces 84 in the three other positions is equally divided into three and average thicknesses between the two broad wide surfaces 22 in regions obtained by equally dividing the straight line into three are D₁, D₂, and D₃, Dₙ>Dₙ₊₁ (where n is 1 or 2) is satisfied. By using the spacer for a battery pack having the above-described configuration, capacity deterioration of the battery pack can be more preferably suppressed. Herein, for example, the average thickness Dₙ can be defined as follows. That is, the corresponding region on the straight line is equally divided into ten and the thickness between the two broad width surfaces is measured at eleven points including ones at both ends. An average value calculated using the respective thicknesses at the eleven points can be used as the average thickness Dₙ.

Although not illustrated in the drawings, a configuration in which, when the straight line drawn from the position P′ to the position Q′ is equally divided into five and average thicknesses between the two broad wide surfaces 22 in regions obtained by equally dividing the straight line into five are D₁, D₂, . . . and D₅ in this order in order of closer from the position P′, Dₙ>Dₙ₊₁ (where n is an integer of any one of 1 to 4) is satisfied can be employed. Moreover, although not illustrated in the drawings, a configuration in which, when the straight line drawn from the position P′ to the position Q′ is equally divided into ten and average thicknesses between the two broad wide surfaces 22 in regions obtained 1w equally dividing the straight line into ten are D₁, D₂, D₃ . . . and D₁₀ in this order in order of closer from the position P′ Dₙ>Dₙ₊₁ (where n is an integer of any one of 1 to 9) is satisfied can be employed. For a maximum thickness of each of D₁, D₂, D₃ . . . and D₁₀, D₁>D₂>D₃ (>D₄ . . . >D₁₀) is preferably satisfied.

The above-described embodiment has been described using the spacer 20 for a battery pack as an example, but does not limit the spacer for a battery pack disclosed herein to the above-described specific example. The battery pack disclosed herein includes various changes made thereto if an object of the above-described specific example is not changed.

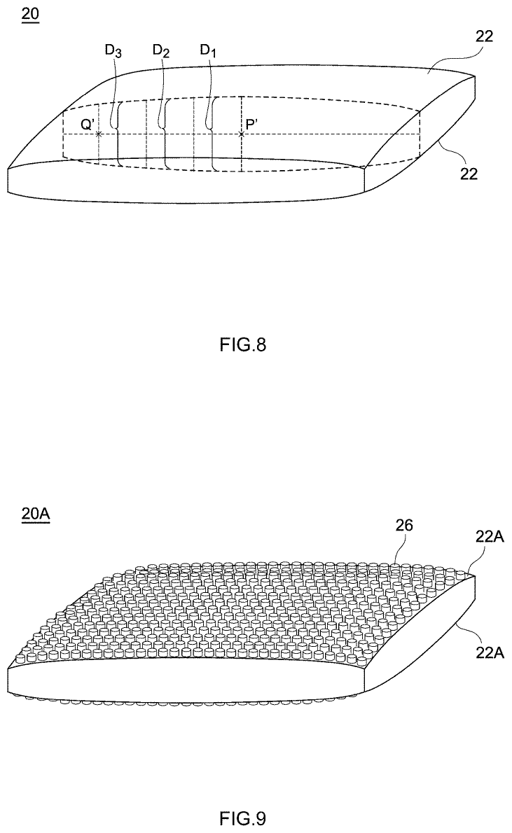

For example, as illustrated in FIG. 9, the spacer for a battery pack disclosed herein can be formed in a configuration in which an elastic surface including a plurality of raised portions 26 formed of an elastic body is formed at least on one of two broad width surfaces 22A. According to the above-described configuration, an elasticity due to crushing of the raised portions 26 can be achieved, and therefore, pushing out of the gas in the electrode body in a more gradual (effective) manner can be realized. In a case where the gas in the electrode body is gradually pushed out, as compared to a case where the gas is rapidly pushed out, the gas can be more effectively discharged to the outside of the electrode body. Note that, in view of more effectively discharging the gas in the electrode body, a case where each of the two broad width surfaces 2A includes the raised portions 26 is preferable. Each of the broad width surfaces 2A may include the raised portions 26 in a portion or an entire surface thereof. In view of more effectively discharging the gas in the electrode body, a case where the broad width surface 22A includes the raised portions 26 in the entire surface is preferable. Note that the spacer 20A for a battery pack can be manufactured, for example, by molding using a metal mode, or the like.

As a material forming the raised portions 26, for example, the materials listed in the paragraph that describes the material forming the spacer 20 for a battery pack can be used without any particular limitation. The material forming the raised portions 26 may be similar to that of a spacer 20A for a battery pack and may be different from that. There is not particular limitation on a shape of each of the raised portions 26 if the effects of the technology limited herein are achieved. The shape can be, for example, a columnar shape, a rectangular parallelopiped shape, a hemispherical shape, or various other shapes. Moreover, two or more types of the above-described shapes can be used in combination. In a case where, for example, columnar or rectangular parallelepiped raised portions are used as the raised portions 26, a magnitude of a long diameter in each of the broad width surfaces can be, for example, about 3 mm to 10 mm, although there is no particular limitation thereon. A thickness of each of the raised portions 26 can be, for example, about 1 mm to 4 mm, although there is no particular limitation thereon.

Herein, in a case where, as the spacer 20A for a battery pack. the spacer for a battery pack includes the raised portions 26, the thickness between the two broad width surfaces of the spacer for a battery pack can be a thickness including a thickness of the raised portions 26.

As for the spacer 20 for a battery pack used in the above-described embodiment, when the spacer for a battery pack in a state where the spacer for a battery pack is not disposed between the battery cells (for example, in a state before the spacer is disposed between the battery cells, or a state after the battery is disassembled) is cut into two in a perpendicular direction to the thickness between the two broad width surfaces (that is, in a Y direction in FIG. 7), the relationship Da>Db described above is satisfied in the two cut bodies 24 (that is, each of the two broad width surfaces has a gradient). However, the spacer for a battery pack disclosed herein is not limited to the above-described spacer, but can be formed such that one of the two broad width surfaces is flat (that is, a configuration similar to the cut bodies 24 of FIG. 6). Note that, as illustrated in FIG. 6, it is preferable that each of the two broad width surfaces has a gradient because the effects of the technology disclosed herein can be more preferably exhibited in such a case. In FIG. 1, seven spacers for a battery pack of the battery pack 1 are formed in the same manner, but are not limited thereto. For example, as a spacer for a battery pack disposed between each of the constraining plates 10 and one of the battery cells 100 adjacent to the constraining plate 10, a spacer formed in the same manner as that of the cut body 24 may be used as appropriate. In this case, a flat surface of the spacer is preferably disposed to be opposed to the corresponding constraining plate.

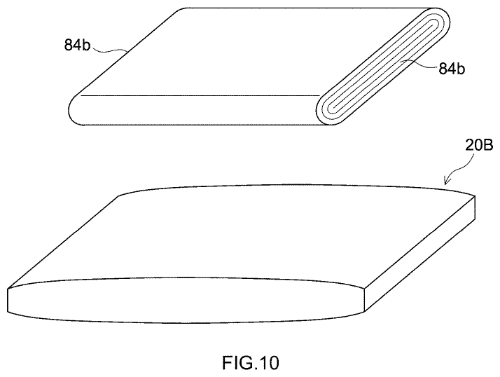

In the above-described embodiment, a case where the stacked electrode body 80 is used as the electrode body has been described as an example. However, for example, as illustrated in FIG. 10, in a case where a wound electrode body is used as the electrode body, a spacer 20B for a battery pack having a gradient toward each of end surfaces 84b in two directions of the positive and negative electrodes-stacked structure is preferably used.

Examples related to the present disclosure will be described below, but are not intended to limit the present disclosure to the example below.

### Manufacturing Evaluation Battery Pack

### First Example

A lithium nickel cobalt manganese composite oxide (NCM) as a positive electrode active material, polyvinylidene fluoride (PVdF) as a binder, and acetylene black (AB) as a conductive material were weighed such that a mass ratio was NCM:PVdF:AB=98:1:1 and were mixed in N-methyl-2-pyrrolidone (NMP) to prepare a positive electrode slurry. The positive electrode slurry was applied to both surfaces of a long belt-like positive electrode core (an aluminum foil, a thickness 12 μm) and was dried. The positive slurry was cut into a predetermined size and was rolled by a roll press, and thus, a positive electrode sheet including a positive electrode active material layer on both surfaces of the positive electrode core was obtained.

Next, graphite powder (C) as the negative electrode active material, styrene butadiene ribber (SBR) as a binder, and carboxymethyl cellulose (CMC) as a thickener were weighted such that a mass ratio was C:SBR:CMC=98:1:1 and were mixed to prepare a negative slurry. The negative electrode slurry was applied to both surfaces of a long belt-like negative electrode core (a copper foil, a thickness of 9 μm) and was dried. The negative slurry was cut into a predetermined size and was rolled by a roll press, and thus, a negative electrode sheet including a negative electrode active material layer on both surfaces of the negative electrode core was obtained.

As a separator, a porous polyolefin sheet made of PE and having a thickness of 14 μm was prepared. The positive electrode sheet and the negative electrode sheet were superimposed with the separator interposed therebetween to obtain a stacked electrode body. The stacked electrode body had a thickness of about 24 mm.

An electrode terminal was attached to the stacked electrode body manufactured in the above-described manner, and then, the stacked electrode body was housed with the a nonaqueous electrolyte in a laminated case. Then, the laminated case was sealed, thereby obtaining a battery cell. Herein, as the nonaqueous electrolyte, an electrolyte obtained by dissolving LiPF₆ as a supporting electrolyte in a mixed solvent containing ethylene carbonate (EC), dimethyl carbonate (DMC), and ethyl methyl carbonate (EMC) in a volume ratio of EC:DMC:EMC=3:3:4 at a concentration of 1.1 mol/L and further dissolving vinylene carbonate (VC) therein at a 2 weight percent was used.

Three battery cells each being configured in the above-described manner were prepared. A spacer for a battery pack (see 20 in FIG. 3) configured such that, in a state where the spacer was not disposed between the battery cells, in a case where, when arbitrary two points on a straight line drawn from a position opposed to a center portion of the electrode body of each of the battery cells to a position opposed to a center portion of each of end surfaces of a positive and negative electrodes-stacked structure in four directions were assumed to be a and b in this order in order of closer from the position opposed to the center position of the electrode body, average thicknesses between two broad width surfaces in sections each extending 1.5 cm from a corresponding one of the points a and b as a center in forward and rearward directions along the straight line were assumed to be Da and Db, a relationship Da>Db was satisfied was prepared. It was confirmed that the spacer for a battery pack prepared in the above-described manner satisfied Dₙ>Dₙ₊₁ (where n was 1 or 2) when, in the state where the spacer was not disposed between the battery cells, a straight line drawn from the position opposed to the center portion of the electrode body of each of the battery cells to the position opposed to the center portion of each of the end surfaces of the positive and negative electrodes-stacked structure in the four directions was equally divided into three and average thicknesses between the two broad width surfaces in regions obtained by equally dividing the straight line into three were assumed to be D1, D2, and D3 in this order in order of closer from the position opposed to the center portion of the electrode.

Herein, as the above-described spacer for a battery pack, a spacer made of ethylene propylene diene rubber (a compression elasticity modulus: 12 MPa, the same applies below) and having a thickness of 3 mm in a center and a thickness of 1.5 mm in an end portion was used. After the spacer for a battery pack was disposed between battery cells and the battery cells were connected in series, the spacer was sandwiched between constraining plates, and thus, an evaluation battery pack according to the first example was obtained (see FIG. 1).

### Second Example

Similar to the first example, a positive electrode sheet and a negative electrode sheet were superimposed with a separator interposed therebetween, and then, were wound and press-processed into a flat shape to obtain a wound electrode body having a flat shape. The wound electrode body had a thickness of about 24 mm. After an electrode terminal was attached to the wound electrode body manufactured in the above-described manner, the wound electrode body was housed with a nonaqueous electrolyte in a laminated case. The laminated case was sealed, thereby obtaining a battery cell.

Three battery cells each being configured in the above-described manner were prepared. A spacer for a battery pack (see 20B in FIG. 10) configured such that, in a state where the spacer was not disposed between the battery cells, in a case where, when arbitrary two points on a straight line drawn from a position opposed to a center portion of the electrode body of each of the battery cell to a position opposed to a center portion of each of end surfaces of a positive and negative electrodes-stacked structure in two directions were assumed to be a and b in this order in order of closer from the position opposed to the center position of the electrode body, average thicknesses between two broad width surfaces in sections each extending 1.5 cm from a corresponding one of the points a and b as a center in forward and rearward directions along the straight line were assumed to be Da and Db, a relationship Da>Db was satisfied was prepared. It was confirmed that the spacer for a battery pack prepared in the above-described manner satisfied Dₙ>Dₙ₊₁ (where n was 1 or 2) when, in the state where the spacer was not disposed between the battery cells, a straight line drawn from the position opposed to the center portion of the electrode body of each of the battery cells to the position opposed to the center portion of each of the end surfaces of the positive and negative electrodes-stacked structure in the two directions was equally divided into three and average thicknesses between two broad width surfaces in regions obtained by equally dividing the straight line into three were assumed to be D1, D2, and D3 in this order in order of closer from the position opposed to the center portion of the electrode.

Herein, as the above-described spacer for a battery pack, a spacer made of ethylene propylene diene rubber and having a thickness of 3 mm in a center and a thickness of 1.5 mm in an end portion was used. After the spacer for a battery pack was disposed between battery cells and the battery cells were connected in series, the spacer was sandwiched between constraining plates, and thus, an evaluation battery pack according to the second example was obtained.

### First Comparative Example

Except that, as the spacer for a battery pack disposed between the battery cells, a spacer made of ethylene propylene diene rubber and having a flat shape without a thickness gradient was used, an evaluation battery pack according to a first comparative example was obtained in a manner similar to that in the first example.

### Second Comparative Example

Except that, as the spacer for a battery pack disposed between the battery cells, a spacer made of ethylene propylene diene rubber and having a fiat shape without a thickness gradient was used, an evaluation battery pack according to a second comparative example was obtained in a manner similar to that in the second example.

### Third Comparative Example

As a spacer for a battery pack, a spacer for a battery pack configured such that, in a state where the spacer was not disposed between the battery cells, in a case where, when arbitrary two points on a straight line drawn from a position opposed to a center portion of the electrode body of each of the battery cell to a position opposed to a center portion of each of end surfaces of a positive and negative electrodes-stacked structure in two directions on which the positive and negative electrodes-stacked structure were not exposed were assumed to be a and b in this order in order of closer from the position opposed to the center position of the electrode body, average thicknesses between two broad width surfaces in sections each extending 1.5 cm from a corresponding one of the points a and b as a center in forward and rearward directions along the straight line were assumed to be Da and Db, a relationship Da>Db was satisfied was prepared. Herein, as the above-described spacer for a battery pack, a spacer made of ethylene propylene diene rubber and having a thickness of 3 mm in a center and a thickness of 1.5 mm in an end portion was used. Other than these points, an evaluation battery pack according to a third comparative example was obtained in a similar manner to that in the second example.

Evaluation Of Capacity Retention Ratio

Each of the evaluation battery packs was placed in an environment at temperature of 45° C. , was charged to 4.2 V at a constant current with a current value of 0.3 C, and thereafter, was discharged to 3.0 V at a constant current with a current value of 0.3 C. A discharge capacity at this time was obtained and was set as an initial capacity. Moreover, a discharge capacity after the above-described charge and discharge cycle had been performed 100 times was obtained in a similar manner to that for the initial capacity. Then, the capacity retention ratio (%) was calculated in accordance with (the discharge capacity after 100 charge and discharge cycles/the initial capacity)×100. Respective capacity retention ratios of the evaluation battery packs were 95% in the first example, 94% in the second example, 90% in the first comparative example, 88% in the second comparative example, and 89% in the third comparative example. Note that, if the capacity retention ratio is over 90%, it is evaluated that reduction in the capacity retention ratio of the battery pack is preferably suppressed (that is, capacity deterioration is preferably suppressed).

Based on the foregoing, it was confirmed that, in the evaluation battery packs according to the first and second examples where the spacer for a battery pack configured such that, in the state where the spacer was not disposed between the battery cells, in a case where, when arbitrary two points on the straight line drawn from the position opposed to the center portion of the electrode body of each of the battery cell to the position opposed to the center portion of each of the end surfaces of the positive and negative electrodes-stacked structure were assumed to be a and b in this order in order of closer from the position opposed to the center position of the electrode body, the average thicknesses between the two broad width surfaces in sections each extending 1.5 cm from the corresponding one of the points a and b as a center in the forward and rearward directions along the straight line were assumed to be Da and Db, the relationship Da>Db was satisfied was used, the capacitance deterioration was preferably suppressed, as compared to the evaluation battery packs according to the first and second comparative examples where the spacer for a battery pack having a flat shape without any thickness gradient was used and the third comparative example where the spacer for a battery pack configured such that, in the state where the spacer was not disposed between the battery cells, in a case where, when arbitrary two points on the straight line drawn from the position opposed to the center portion of the electrode body of each of the battery cells to the position opposed to the center portion of the end surface of the positive and negative electrodes-stacked structure on which the positive and negative electrodes-stacked structure were not exposed were assumed to be a and b in this order in order of closer from the position opposed to the center position of the electrode body, the average thicknesses between the two broad width surfaces in the sections each extending 1.5 cm from the corresponding one of the points a and b as a center in the forward and rearward directions along the straight line were assumed to be Da and Db, the relationship Da>Db was satisfied was used.

Specific examples of the present disclosure have been described in detail above, but these are merely examples and do not limit the scope of the claims. The technology described in the scope of the claims includes various modifications and changes of the specific examples described above.

1. A spacer for a battery pack having a sheet-like shape and disposed between arranged battery cells, wherein:
a battery pack configured such that a plurality of battery cells each including an electrode body having a positive and negative electrodes-stacked structure in which a positive electrode and a negative electrode are stacked with a separator interposed therebetween are arranged in a stacking direction of the positive and negative electrodes, the spacer comprising:
two broad width surfaces each being opposed to a corresponding one of the battery cells adjacent to the spacer in the stacking direction in a case where the spacer is disposed between the battery cells, wherein:
in the spacer in a state where the spacer is not disposed between the battery cells, in a case where, when arbitrary two points on a straight line drawn from a position opposed to a center portion of the electrode body of each of the battery cells to a position opposed to a center portion of an end surface of the positive and negative electrodes-stacked structure are assumed to be a and b in this order in order of closer from the position opposed to the center portion of the electrode body, average thicknesses between the two broad width surfaces in sections each extending 1.5 cm from a corresponding one of the points a and b as a center in forward and rearward directions along the straight line are assumed to be Da and Db, a relationship Da>Db is satisfied.

2. The spacer for a battery pack according to claim 1, wherein:
the spacer for a battery pack is formed of an elastic body.

3. The spacer for a battery pack according to claim 2, wherein:
a compression elasticity modulus of the elastic body is 120 MPa or less.

4. The spacer for a battery pack according to claim 1, wherein:
an elastic surface including a plurality of raised portions formed of an elastic body is formed on at least one of the two broad width surfaces.

5. The spacer for a battery pack according to claim 1, wherein:
in the state where the spacer for a battery pack is disposed between the battery cells, when each of the battery cells adjacent in the stacking direction has a SOC of 90% or more, a state where the thickness between the two broad width surfaces is flat is realized.

6. The spacer for a battery pack according to claim 1, wherein:
when the spacer in a state where the spacer is not disposed between the battery cells is cut into two in a perpendicular direction to the thickness between the two broad width surfaces, the relationship Da>Db is satisfied in the two cut bodies.

7. The spacer for a battery pack according to claim 1, wherein:
in the spacer in a state where the spacer is not disposed between the battery cells, when a straight line drawn from the position opposed to the center portion of the electrode body of each of the battery cells to the position opposed to the center position of the end surface of the positive and negative electrodes-stacked structure is equally divided into three and average thicknesses between the two broad width surfaces in regions obtained by equally dividing the straight line into three are assumed to be D₁, D₂, and D₃ in this order in order of closer from the position opposed to the center position of the electrode body, a relationship Dₙ>Dₙ₊₁ (where n is 1 or 2) is satisfied.

8. A battery pack comprising:
the spacer for a battery pack according to claim 1.

9. The battery pack according to claim 8, wherein:
each of the battery cells is configured such that the electrode body is covered by a laminated exterior body.
